(19) United States
(12) Patent Application Publication
(10) Pub. No.: US 2013/0041836 A1
(43) Pub. Date: Feb. 14, 2013

(54) VESSEL SCHEDULE OPTIMIZATION

(71) Applicant: Sundar Arunapuram, West Chester, PA (US)

(72) Inventor: Sundar Arunapuram, West Chester, PA (US)

(73) Assignee: ORACLE INTERNATIONAL CORPORATION, Redwood Shores, CA (US)

(21) Appl. No.: 13/207,758

(22) Filed: Aug. 11, 2011

(51) Int. Cl. G06Q 30/00

(52) U.S. Cl. 705/338

(57) ABSTRACT

One embodiment is a vessel schedule optimization system and method that determines and schedules the optimal land and ocean shipments for a group of orders. The method includes creating an order bundle, the order bundle including orders that have the same origin and destination location and have overlapping time windows for pickup and delivery. The method also includes dividing the order bundle into equipment sized bundles, such that each of the equipment sized bundles include orders that can fit in the same equipment. The method further includes, for each of the equipment sized bundles, identifying available origin ports, destination ports, and voyages for handling the equipment sized bundle. The method then includes building land and ocean shipments for each of the equipment sized bundles based on the identified origin ports and destination ports.

### FIELD

One embodiment is directed generally to computerized logistics and, in particular, to a computer system configured to generate an optimized plan for vessel scheduling.

### BACKGROUND INFORMATION

Companies that sell or deliver goods, as well as operators of fleet vehicles and/or ocean vessels, need to monitor and manage the deployment, location, and routes of their shipments. Companies seek to do so in a manner that increases asset utilization, lowers transportation costs, meets scheduling requirements, and complies with local and national regulations related to employment, environment, etc. For example, one aspect of the monitoring and managing of shipments is being able to determine how to efficiently and optimally determine and assign resources, vehicles, vessels and/or voyages to certain shipments or orders.

For example, many companies or shippers may need to ship a group of orders from an origin location in one region of the world to a destination in a different region through a network of land, ocean, and land moves. Each order has an available pick up window during which orders must be picked up at the origin location, and a delivery time window during which the order must be delivered at the destination location. The land portions of the orders' movements are typically performed using trucks, whereas the ocean portion is performed using ocean carrier voyages serviced by different service providers. Therefore, optimally determining the appropriate origin port and destination port, as well as the right voyage and equipment can post a significant challenge for shippers.

### SUMMARY

One embodiment is directed to a computer program, embodied on a computer readable medium. The computer program is configured to control a processor to perform a process that includes creating an order bundle. The order bundle includes a plurality of orders that have a same origin and destination location and have overlapping time windows for pickup and delivery. The process further includes dividing the order bundle into equipment sized bundles, where each of the equipment sized bundles include orders that can fit in the same equipment. The process also includes, for each of the equipment sized bundles, identifying available origin ports, destination ports, and voyages for handling the equipment sized bundle. The process then includes building land and ocean shipments for each of the equipment sized bundles based on the identified origin ports and destination ports.

### BRIEF DESCRIPTION OF THE DRAWINGS

FIG. 1 illustrates a system according to one embodiment of the invention;

FIG. 2 illustrates a system according to another embodiment;

FIG. 3 illustrates a graphical user interface according to an embodiment;

FIG. 4 illustrates a flow diagram of a method according to an embodiment; and

FIG. 5 illustrates a flow diagram of a method according to another embodiment.

### DETAILED DESCRIPTION

With the increase in global trade and manufacturing, numerous goods need to be shipped between countries and across continents. Accordingly, in many instances, companies and individuals are required to ship orders of goods from an origin location in one part of the world to a destination location in another region of the world through a network of truck and ocean carriers. For example, an order may be picked up from its origin location by a truck and transported to an origin port and placed on an ocean vessel. The ocean vessel may then transport the order to a destination port in another country or continent, where the order is picked up by a truck for delivery to its destination location. Entities that are shipping and/or receiving these goods require a mechanism for planning shipments in a manner that minimizes the overall costs of moving the goods.

Therefore, one embodiment of the present invention provides a vessel schedule optimization system and method that determines and schedules the optimal land and ocean shipments for a group of orders. The vessel schedule optimization system and method is able to plan the moves for the orders in a way that minimizes the overall cost of the shipments, while simultaneously fulfilling any scheduling requirements for each of the shipments.

It should be noted that, in this description, “equipment” may be referred to as resources, containers, trailers, or the like. According to certain embodiments, equipment can be anything used to store, transport, or ship items such as goods or products.

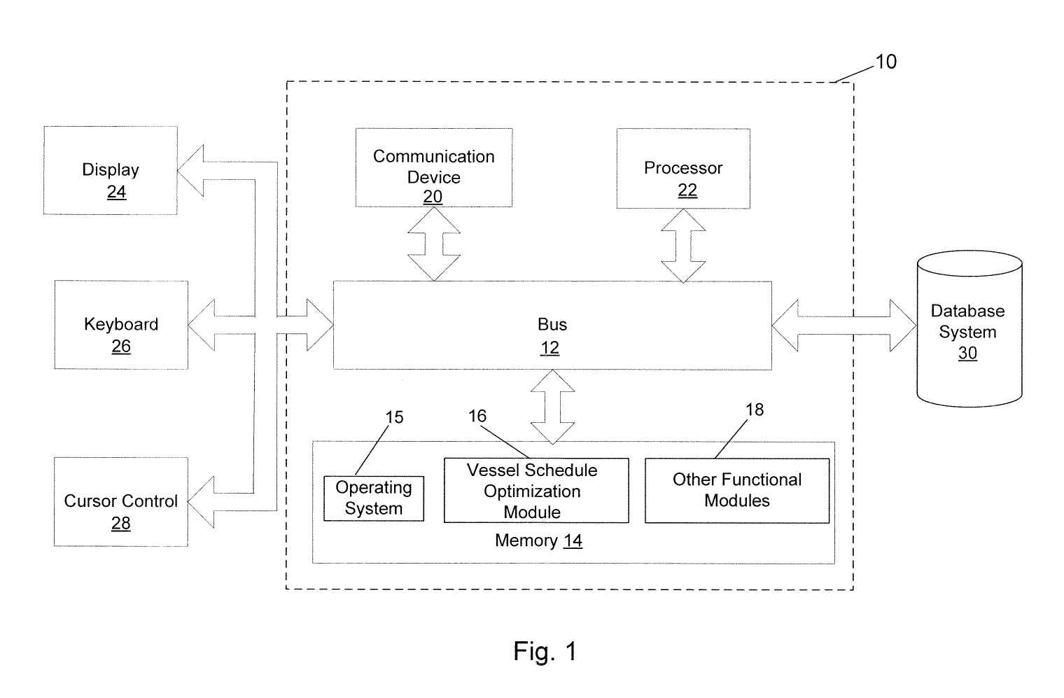

FIG. 1 illustrates a block diagram of a system 10 that may perform vessel schedule optimization, according to one embodiment. System 10 includes a bus 12 or other communications mechanism for communicating information between components of system 10. Alternatively, the components of system 10 may communicate with each other directly without the use of bus 12.

System 10 also includes a processor 22, coupled to bus 12, for processing information and executing instructions or operations. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of machine or computer readable media. System 10 further includes a communication device 20, such as a network interface card or other communications interface, to provide access to a network. As a result, a user may interface with system 10 directly or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user, such as the load placement of a container, as will be discussed in more detail below. A keyboard 26 and a cursor control device 28, such as a computer mouse, are further coupled to bus 12 to enable a user to interface with system 10.

Processor 22 and memory 14 may also be coupled via bus 12 to a database system 30 and, thus, may be able to access and retrieve information stored in database system 30. Although only a single database is illustrated in FIG. 1, any number of databases may be used in accordance with certain embodiments. In some embodiments, database system 30 may store information related to items for shipping including their dimensions, weight, volume, destination, and any other relevant attributes. Database system 30 may store information related to containers, including their size, dimensions, attributes such as any obstructions, etc.

In one embodiment, memory 14 stores software modules that provide functionality when executed by processor 22. The modules may include an operating system 15 that provides operating system functionality for system 10. The memory may also store a vessel schedule optimization module 16, which can provide the functionality for determining and scheduling the optimal land and ocean shipments for a group of orders, according to one embodiment.

System 10 may also include one or more other functional modules 18 to provide additional functionality. For example, functional modules 18 may include a transportation management system capable of facilitating the planning and building of shipments. In one embodiment, functional modules 18 may include, for instance, the Oracle Transportation Management (OTM) system from Oracle Corporation.

Database system 30 may include a database server and any type of database, such as a relational or flat file database. Database system 30 may store attributes related to items and container, as well as constraints provided by the transportation management system or a user. Database system 30 may also store any other data required by the vessel schedule optimization module 16, or data associated with system 10 and its associated modules and components.

In certain embodiments, processor 22, vessel schedule optimization module 16, and other functional modules 18 may be implemented as separate physical and logical units or may be implemented in a single physical and logical unit. Furthermore, in some embodiments, processor 22, vessel schedule optimization module 16, and other functional modules 18 may be implemented in hardware, or as any suitable combination of hardware and software.

In one embodiment, vessel schedule optimization module 16 is configured to control system 10 to perform a process of determining and scheduling a group of orders for shipment from an origin location to a destination location via a pair of ports, for example. The process may include the vessel schedule optimization module 16 receiving or retrieving a list of orders for shipping. The list may be stored in database system 30, as discussed above, or may be received from an external system or database.

According to an embodiment, vessel schedule optimization module 16 is configured to control system 10 to create an order bundle from the list of orders. In one example, an order bundle includes one or more orders that have the same origin and destination location, have overlapping time windows for pickup and delivery, and have other matching criteria. Vessel schedule optimization module 16 may then control system 10 to divide the created order bundle into equipment sized bundles.

In one embodiment, each of the equipment sized bundles comprise orders that can fit in the same equipment and can travel on the same equipment for both the land and ocean legs of the shipment. For example, all orders within the same equipment sized bundle can fit together in the same truck for delivery to the origin port and for delivery from the destination port, as well as be able to fit in the same ocean vessel for delivery from the origin port to the destination port. More specifically, according to one embodiment, the orders within an equipment sized bundle should be able to make the exact same voyage given their pickup and delivery time windows, the transit time on the origin land leg from the origin location to the origin port, the voyage cutoff time, the voyage schedule time and voyage duration, the recovery time at the destination port, and the transit time on the destination land leg from the destination port to the destination location. The voyage cutoff time at the origin port refers to the time within which orders must be present or arrive at the origin port to make the voyage. For instance, some ports and voyages require that the orders arrive at the port 24 hours before the voyage departs. The recovery time at the destination port refers to the time it takes to release an order at the destination port after it arrives.

Furthermore, for each of the equipment sized bundles, vessel schedule optimization module 16 is configured to control system 10 to identify available origin ports, destination ports, and voyages for handling the equipment sized bundle. Then, based on the identified origin ports and destination ports, vessel schedule optimization module 16 can control system 10 to build land and ocean shipments for each of the equipment sized bundles.

For every voyage, system 10 is controlled to retrieve and store a voyage ID, voyage depart date/time from the origin port, voyage arrival date/time at the destination port, cutoff time at the origin port, recovery time at the destination port, transit time from the origin location to the origin port, and transit time from the destination port to the destination location.

According to certain embodiments, voyage schedules are cached in order to provide faster and easier access to voyage schedule information from system 10. In one embodiment, at least two caches are created which include the voyage primary key cache and a location month cache. The location month cache stores all the voyages from a port for a given month. This allows for easy retrieval of schedule information for all the voyages from a given port over certain dates.

Therefore, embodiments of the invention provide the ability to optimize the scheduling and delivery of orders as a whole by breaking up the orders into bundles based on the schedules, equipment capacity, and costs of land moves and voyage moves.

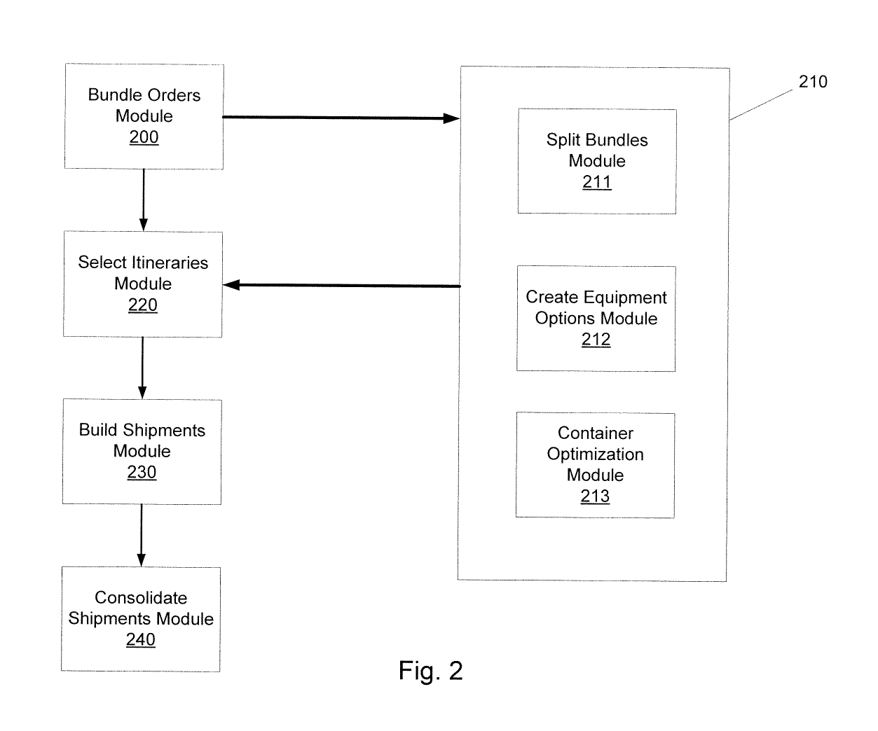

FIG. 2 is a diagram illustrating the components of a system or framework for building equipment sized bundles that can then be used to build and schedule the shipments, according to one embodiment. The system of FIG. 2 includes a bundle orders module 200 configured to bundle orders into a group such that they have the same origin and destination location, have overlapping time windows for pickup and delivery, and have other matching criteria. The order bundles created by bundle orders module 200 is provided to a bundle splitter logic module 210 that is configured to split the bundles to create equipment sized bundles.

Bundle splitter logic module 210 includes a split bundles module 211 configured to split the order bundles using at least the voyage schedules. In this way, orders that cannot travel on the same voyage will be split into separate bundles. Bundle splitter logic module 210 also includes create equipment options module 212 which is configured to provide equipment options for the orders. Create equipment options module 212 can call container optimization module 213 which is configured to simulate the packing of the orders into container(s). One example of the container optimization module and the methods used to simulate the packing of items into containers is described in U.S. patent application Ser. No. 13/111,120, filed on May 19, 2011 and entitled “A Framework for Optimized Packing of Items into a Container.” The entire contents of U.S. patent application Ser. No. 13/111,120 is hereby incorporated by reference in its entirety.

According to certain embodiments, container optimization module 213 may invoke different solvers, such as a multi-container mixed integer programming (MIP) solver, a heuristic solver, and a column generation solver, to aid in the selection of the number and type of equipment or containers and to provide the optimal way of packing items into the containers.

Multi-container MIP solver is capable of optimally selecting the right combination of resources or containers to pack a set of items. The objective of multi-container MIP solver may be to minimize the total number of containers used and/or minimize the cost. For each resource or container type, multi-container MIP solver estimates the number of containers of those type that are needed to pack all of the items. Multi-container MIP solver is also able to mix different resource or containers types to provide an estimate that uses more than one type of resource or container. In some embodiments, multi-container MIP solver utilizes heuristic solver with a quick packing method, to perform the estimation of numbers of resources needed for each resource type. As a result, multi-container MIP solver produces multiple estimates of the number of containers needed depending on the container type.

Multi-container MIP solver may then formulate an assignment problem with side constraint(s) to assign the items in each of the multiple estimates previously produced. The constraints may include, for example, weight, volume, and equipment replaceable units (ERUs). The problem is then solved, in one embodiment, using an optimization solver, and producing, as an output, the optimal assignment of items to container(s).

According to certain embodiments, the heuristic solver employs different packing methods or algorithms iteratively to simulate the packing of one container at a time. The packing methods may include quick packing, single container MIP packing, enumerative packing, and/or three dimensional load packing. According to an embodiment, the heuristic solver is provided with a set of items, set of resources, and a packing method as inputs. The heuristic solver can then find the best fit container for packing. To do so, the heuristic solver uses the remaining items to be packed and packs them into each resource type using the provided packing method. The heuristic solver then selects the best packed resource according to a given criteria. For example, the criteria used to determine the best packed resource may include the one that minimizes cost, maximizes utilization, and/or minimizes containers. The best resource as determined according to the selected criteria is then added to a list of packed resources. The Heuristic solver repeats the above steps adding packed resources to the list, until there are no more items remaining for packing. When it is determined that no more items remain, heuristic solver returns the packed resource list to container optimization module 213.

In one embodiment, container optimization module 213 is schedule aware because it is configured to understand the voyage schedules such that it determines that certain orders may not be able to be packed together. As a result, container optimization module 213 can use the voyage schedules to pack orders into containers accordingly. In order to do so, container optimization module 213 receives the orders' time windows including pickup and delivery time windows, transit time from the origin location to the origin port, and transit time from the destination port to the destination location. Container optimization module 213 also receives the voyage schedule information including, for example, voyage depart date/time from the origin port, voyage arrival date/time at the destination port, cutoff time at the origin port, and recovery time at the destination port. Using this information, container optimization module 213 is able to pack containers with orders that can be delivered together.

In one embodiment, container optimization module 213 will check the compatibility of an order with those already included in a partially packed container before placing the order in that container. If the order is compatible with those already packed in terms of schedule, then the order can be placed in the container. If the order is not compatible, then container optimization module 213 will search for other schedules that may be compatible with all orders. If container optimization module 213 is able to find another schedule that is compatible with all the orders, then it will replace the current schedule with the newly found schedule and pack the order into the container. However, if container optimization module 213 is unable to find another schedule that is compatible with all the orders, then the order cannot be added to the partially packed container. Thus, container optimization module 213 is able to optimally pack orders into equipment and also provide the schedule that is feasible for these orders.

As mentioned above, the output of bundle splitter logic module 210 includes one or more equipment sized bundles. Select itineraries module 220 can then select an itinerary for each of the equipment sized bundles. In one embodiment, an itinerary may be considered a path from an origin location, through a pair of ports, to a destination location. Based on the selected itineraries, build shipments module 230 builds the shipments for the equipment sized bundles. The shipments may include a land leg for shipping the orders from the origin location to the origin port, a voyage for shipping the orders via an ocean vessel from the origin port to a destination port, and a second land leg for delivering the orders from the destination port to the destination location. Consolidate shipments module 240 is configured to combine two or more equipment sized bundles if it is feasible to do so.

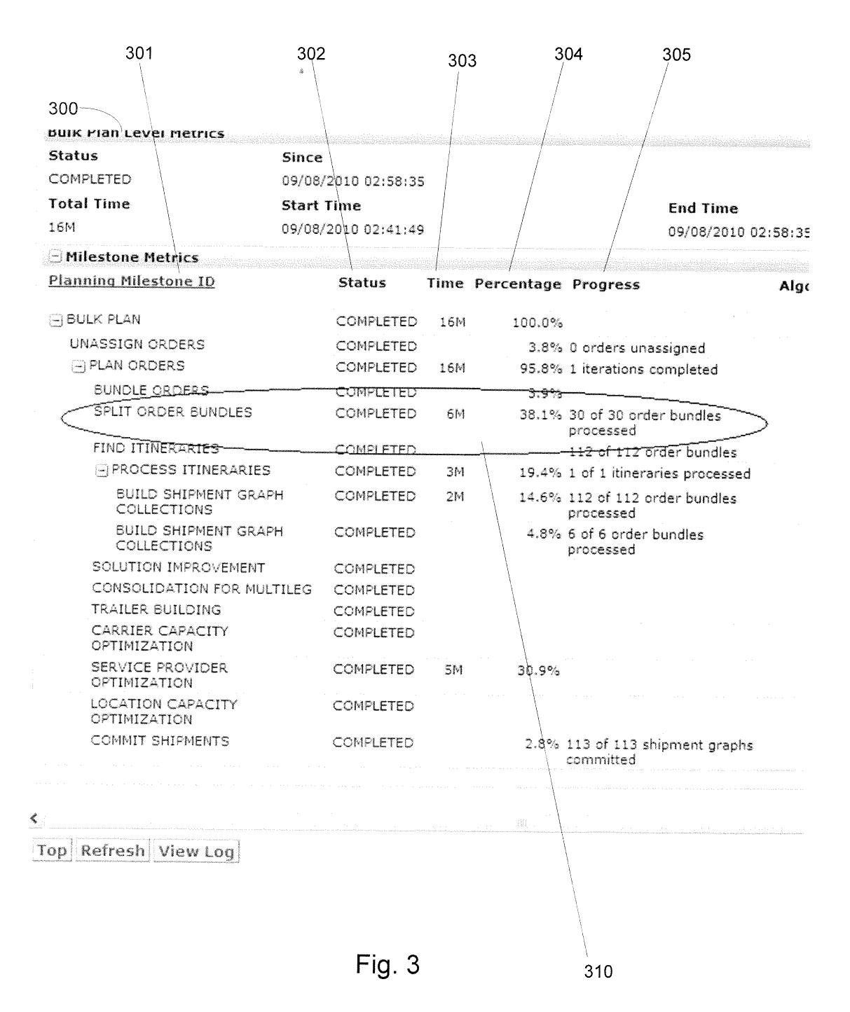

FIG. 3 illustrates an example of a user interface 300 for displaying milestones related to the planning and building of shipments. As shown in FIG. 3, user interface 300 can include a planning milestone ID column 301 listing the different milestones associated with building the shipments. Status column 302 of user interface 300 lists the status of each of the milestones. In this example, all of the milestones have a completed status. Time column 303 lists the runtime for the associated milestone. Percentage column 304 lists the percentage of total runtime it took to complete the associated milestone, and progress column 305 shows the progress of the milestone. For example, split order bundles row 310 shows a completed status, with a runtime of 6 minutes that is 38.1% of the total runtime, and 30 of 30 order bundles processed.

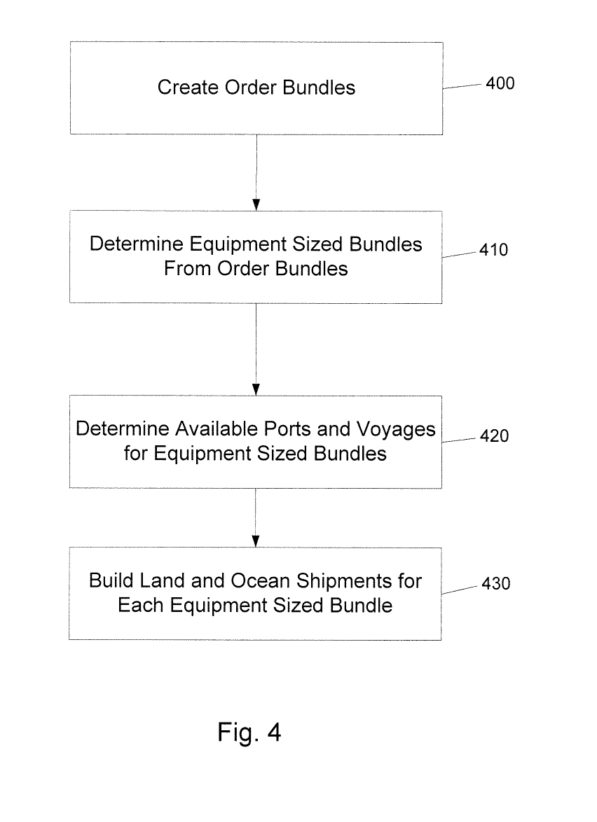

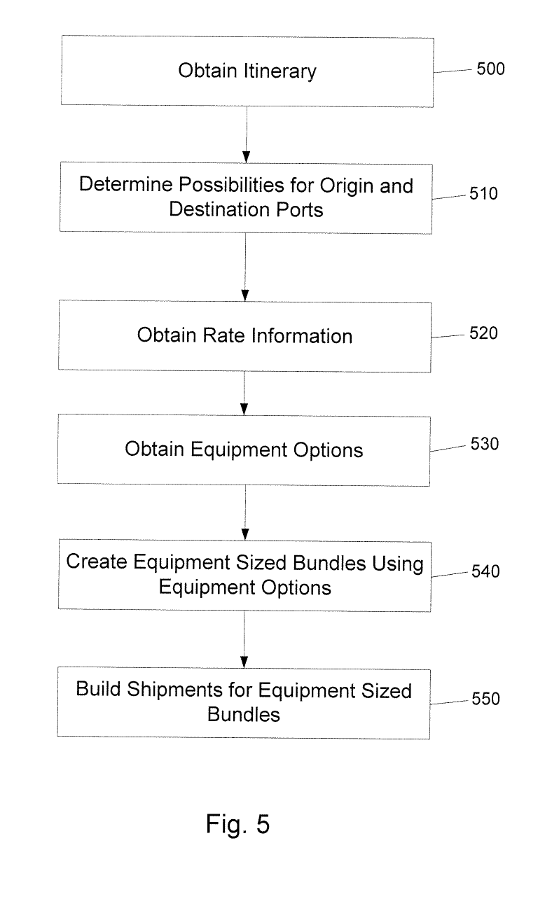

FIG. 4 is a flow diagram of a process for scheduling the delivery of orders, according to one embodiment. In certain embodiments, the functionality of the flow diagram of FIG. 4, and FIG. 5 discussed below, is implemented by software stored in memory or other computer readable or tangible media, and executed by a processor. In other embodiments, the functionality may be performed by hardware (e.g., through the use of an application specific integrated circuit (ASIC), a programmable gate array (PGA), a field programmable gate array (FPGA), etc.), or any combination of hardware and software.

Referring to FIG. 4, at 400, order bundles are created such that each of the order bundles include orders that have a same origin and destination location and have overlapping time windows for pickup and delivery. At 410, equipment sized bundles are created from the order bundles. In one embodiment, an order bundle is divided into equipment sized bundles that each include orders that can fit in the same equipment. At 420, for each of the equipment sized bundles, the available origin ports, destination ports, and voyages for handling the equipment sized bundle are identified. At 430, land and ocean shipments for each of the equipment sized bundles are identified and created, based on the identified origin ports and destination ports.

FIG. 5 illustrates a flow diagram of a process for creating an equipment sized bundle, such as for 410 of FIG. 4, according to one embodiment. At 500, an itinerary for each of the orders in a given order bundle is obtained. In this embodiment, the itinerary may include at least the origin location and source location. Optionally, the itinerary may include the date/time window for picking up the order from the origin location and the date/time window for delivering the order to the destination location. At 510, the possible origin ports and destination ports for use in delivering the orders are determined. In many instances, there could be more than one origin port and destination port that can be utilized to deliver the orders. At 520, the rate information or cost for all the possible origin and destination port combinations is determined. In one embodiment, the rate information is obtained from a rating engine that is configured to obtain, store and periodically update rate information. The rate information may include, for example, the cost of transporting the order from the origin location to an origin port, the cost of the voyage from the origin port to a destination port, and the cost of transporting the order from the destination port to the destination location.

At 530, equipment options for the order(s) is determined. In one embodiment, the equipment options are determined by invoking container optimization module 213 of FIG. 2, which simulates the packing of the orders. At 540, equipment sized bundles are created using the determined equipment options. The equipment sized bundles may contain information regarding the itinerary and the origin and destination port pair. At 550, the shipment from the origin location to the destination location, via the origin and destination port pair, is built for the equipment sized bundle.

Accordingly, embodiments of the present invention are able to optimize the orders as a whole by breaking them up into bundles based on schedules, equipment capacity and costs of land moves and voyages. As a result, certain embodiments are able to produce optimal solutions for determining and scheduling the optimal land and ocean shipments for a group of orders.

It should be noted that many of the functional features described in this specification have been presented as modules, applications or the like, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be partially implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve its stated purpose.

Indeed, a module of executable code or algorithm could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer program, embodied on a computer readable medium, the computer program configured to control a processor to perform a process, comprising:
creating an order bundle, wherein the order bundle comprises a plurality of orders that have a same origin and destination location;
dividing the order bundle into equipment sized bundles, wherein each of the equipment sized bundles comprise orders that can fit in the same equipment;
for each of the equipment sized bundles, identifying available origin ports, destination ports, and voyages for handling the equipment sized bundle; and
building land and ocean shipments for each of the equipment sized bundles based on the identified origin ports and destination ports.

2. The computer program according to claim 1, wherein the dividing comprises obtaining an itinerary for each of the orders.

3. The computer program according to claim 2, wherein the dividing comprises obtaining costs for each of the identified origin ports, destination ports, and voyages.

4. The computer program according to claim 3, wherein the dividing comprises obtaining equipment options for each of the orders.

5. The computer program according to claim 4, wherein the dividing comprises using the itinerary, the costs, and the equipment options to create the equipment sized bundles.

6. The computer program according to claim 1, wherein each of the voyages has an associated voyage ID, voyage depart time, voyage arrival time, cutoff time at origin port, and recovery time at destination port.

7. The computer program according to claim 1, wherein the plurality of orders in the order bundle have overlapping time windows for pickup and delivery.

8. An apparatus, comprising:
a creator configured to create an order bundle, wherein the order bundle comprises a plurality of orders that have a same origin and destination location and have overlapping time windows for pickup and delivery;
a divider configured to divide the order bundle into equipment sized bundles, wherein each of the equipment sized bundles comprise orders that can fit in the same equipment;
for each of the equipment sized bundles, an identifier configured to identify available origin ports, destination ports, and voyages for handling the equipment sized bundle; and
a builder configured to build land and ocean shipments for each of the equipment sized bundles based on the identified origin ports and destination ports.

9. The apparatus according to claim 8, wherein the divider is further configured to obtain an itinerary for each of the orders.

10. The apparatus according to claim 9, wherein the divider is further configured to obtain costs for each of the identified origin ports, destination ports, and voyages.

11. The apparatus according to claim 10, wherein the divider is further configured to obtain equipment options for each of the orders.

12. The apparatus according to claim 11, wherein the divider is further configured to use the itinerary, the costs, and the equipment options to create the equipment sized bundles.

13. The apparatus according to claim 8, wherein each of the voyages has an associated voyage ID, voyage depart time, voyage arrival time, cutoff time at origin port, and recovery time at destination port.

14. A method, comprising:
creating an order bundle, wherein the order bundle comprises a plurality of orders that have a same origin and destination location;
dividing the order bundle into equipment sized bundles, wherein each of the equipment sized bundles comprise orders that can fit in the same equipment;
for each of the equipment sized bundles, identifying available origin ports, destination ports, and voyages for handling the equipment sized bundle; and
building land and ocean shipments for each of the equipment sized bundles based on the identified origin ports and destination ports.

15. The method according to claim 14, wherein the dividing comprises obtaining an itinerary for each of the orders.

16. The method according to claim 15, wherein the dividing comprises obtaining costs for each of the identified origin ports, destination ports, and voyages.

17. The method according to claim 16, wherein the dividing comprises obtaining equipment options for each of the orders.

18. The method according to claim 17, wherein the dividing comprises using the itinerary, the costs, and the equipment options to create the equipment sized bundles.

19. The method according to claim 14, wherein each of the voyages has an associated voyage ID, voyage depart time, voyage arrival time, cutoff time at origin port, and recovery time at destination port.

20. The method according to claim 14, wherein the plurality of orders in the order bundle have overlapping time windows for pickup and delivery.
